(19) United States
(12) Patent Application Publication
(10) Pub. No.: US 2009/0125347 A1
(43) Pub. Date: May 14, 2009

(54) Determining Lease Quality

(75) Inventors: Robert G. Becker, Charlotte, NC (US); Guy H. Volz, Matthews, NC (US); David G. Mau, Seattle, WA (US)

Correspondence Address: BANNER & WITCOFF, LTD;ATTORNEYS FOR CLIENT NUMBER 007131, 10 SOUTH WACKER DR., SUITE 3000, CHICAGO, IL, 60606, US

(73) Assignee: BANK OF AMERICA CORPORATION, Charlotte, NC (US)

(21) Appl. No.: 11/939,852

(22) Filed: Nov. 14, 2007

(51) Int. Cl. G06Q 10/00

(52) U.S. Cl. 705/7

(57) ABSTRACT

Leases and other types of agreements may be evaluated based on factors including time to delivery, cost of the agreement and/or quality of agreement. According to one or more aspects, the quality of an agreement may be judged based on the rights and/or provisions obtained in the lease. In one example, points may be awarded for each category (e.g., time, cost and/or quality) based on goals that are met. The points may be totaled and combined to form a composite lease quality score or index. A commission for a partner entity procuring the lease may be determined based on the composite lease quality score or index. For example, if the lease quality index is in a median range, the standard or average commission may be awarded. However, if the lease quality index is at least one standard deviation greater than the median, a higher commission may be awarded.

### BACKGROUND

Leasing can often be a complex and time consuming ordeal that many companies and entities contract out to partner entities such as brokers, real estate agents, lawyers and the like. In many instances, the leases procured by the partner entities are merely judged on the lease cost (e.g., the first year of rent). Commission is similarly awarded based on the lease cost. However, evaluating leases and awarding commission based solely on lease cost may lead to less focus on other aspects of a lease such as lease provisions and/or timeliness with which the lease is procured.

### SUMMARY

Aspects of a method and system of determining lease quality may include generating a lease quality index based on an evaluation of two or more of time, cost and quality. Time generally relates to a time to lease completion or cycle time while cost relates to a cost of the lease. Quality refers to provisions in the lease that may be important or significant to a leasing entity. For example, quality parameters may include termination rights, exclusivity rights, signage provisions and the like. Each lease parameter (e.g., time, cost and/or quality) may receive a separate score based on the various goals that are achieved. The individual scores may then be combined to form a composite lease quality score. In some instances, the composite lease quality score may constitute a lease quality index. A commission may then be determined based on the relative strength of the lease quality index as compared to other leases procured for the same entity and/or in the market as a whole.

According to one or more aspects, a scoring rubric may be determined based on various factors such as customer or client preferences and opinions, benchmark samples, baseline samples and the like. For example, important or significant lease provisions and parameters may be specified by polling one or more leasing clients. Goals and scores for each of the provisions and parameters may then be determined based on benchmark and baselines samples. Benchmark samples may generally include lease samples from a collection of leases procured for clients other than a particular entity while baseline samples may generally include samples from a collection of leases procured for the particular entity. In one example, the achievement of termination rights alone might garner a partner entity 0 points (i.e., meeting a median might not be awarded points). However, obtaining termination rights along with the termination rights lasting for at least 30% of the life of the lease may be awarded 1 point. Various scoring rubrics and guidelines may be used in place or in addition to those discussed.

This summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

The foregoing summary of the claimed subject matter, as well as the following detailed description of illustrative embodiments, is better understood when read in conjunction with the accompanying drawings, which are included by way of example, and not by way of limitation with regard to the claimed subject matter.

FIG. 1 illustrates a computing environment in which one or more aspects described herein may be implemented.

FIG. 2 illustrates a transaction processing environment according to one or more aspects described herein.

FIG. 3 is a flowchart illustrating a method for determining a lease quality index and a commission according to one or more aspects described herein.

FIG. 4 is a flowchart illustrating a method for determining performance benchmarks and baselines according to one or more aspects described herein.

FIG. 5 illustrates a data entry form interface for entry and submission of lease quality information according to one or more aspects described herein.

FIG. 6 illustrates a quality parameter scoring rubric according to one or more aspects described herein.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized and structural and functional modifications may be made without departing from the scope of the present claimed subject matter.

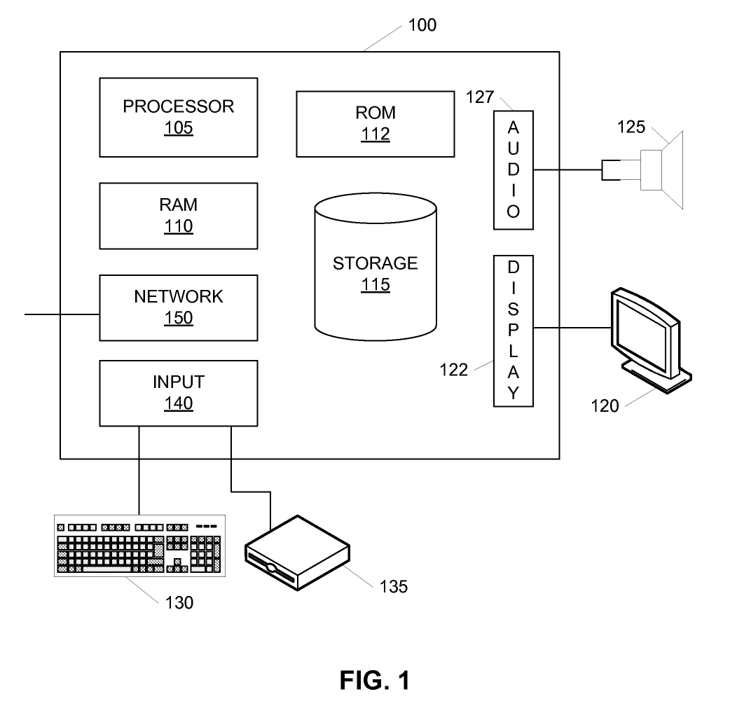

FIG. 1 illustrates a computing environment in which one or more aspects described herein may be implemented. A computing device such as computer 100 may house a variety of components for inputting, outputting, storing and processing data. For example, processor 105 may perform a variety of tasks including executing one or more applications, retrieving data from a storage device such as storage 115 and/or outputting data to a device such as display 120. Processor 105 may be connected to Random Access Memory (RAM) module 110 in which application data and/or instructions may be temporarily stored. RAM module 110 may be stored and accessed in any order, providing equal accessibility to the storage locations in RAM module 110. Computer 100 may further include Read Only Memory (ROM) 112 which allows data stored thereon to persist or survive after computer 100 has been turned off. ROM 112 may be used for a variety of purposes including for storage of computer 100's Basic Input/Output System (BIOS). ROM 112 may further store date and time information so that the information persists even through shut downs and reboots. In addition, storage 115 may provide long term storage for a variety of data including applications and data files. Storage 115 may include any of a variety of computer readable mediums such as disc drives, optical storage mediums, magnetic tape storage systems, flash memory and the like. In one example, processor 105 may retrieve an application from storage 115 and temporarily store the instructions associated with the application RAM module 110 while the application is executing.

Computer 100 may output data through a variety of components and devices. As mentioned above, one such output device may be display 120. Another output device may include an audio output device such as speaker 125. Each output device 120 and 125 may be associated with an output adapter such as display adapter 122 and audio adapter 127, which translates processor instructions into corresponding audio and video signals. In addition to output systems, computer 100 may receive and/or accept input from a variety of input devices such as keyboard 130, storage media drive 135 and/or microphone (not shown). As with output devices 120 and 125, each of the input devices 130 and 135 may be associated with an adapter 140 for converting the input into computer readable/recognizable data. In one example, voice input received through microphone (not shown) may be converted into a digital format and stored in a data file. In another example, credit card input may be received through a card reader (not shown) and converted into a digital format. In one or more instances, a device such as media drive 135 may act as both an input and output device allowing users to both write and read data to and from the storage media (e.g., DVD-R, CD-RW, etc.).

Computer 100 may further include one or more communication components for receiving and transmitting data over a network. Various types of networks include cellular networks, digital broadcast networks, Internet Protocol (IP) networks and the like. Computer 100 may include adapters suited to communicate through one or more of these networks. In particular, computer 100 may include network adapter 150 for communication with one or more other computer or computing devices over an IP network. In one example, adapter 150 may facilitate transmission of data such as electronic mail messages and/or financial data over a company or organization's network. In another example, adapter 150 may facilitate transmission or receipt of information from a world wide network such as the Internet. Adapter 150 may include one or more sets of instructions relating to one or more networking protocols. For example adapter 150 may include a first set of instructions for processing IP network packets as well as a second set of instructions associated with processing cellular network packets. In one or more arrangements, network adapter 150 may provide wireless network access for computer 100.

One of skill in the art will appreciate that computing devices such as computer 100 may include a variety of other components and is not limited to the devices and systems described in FIG. 1.

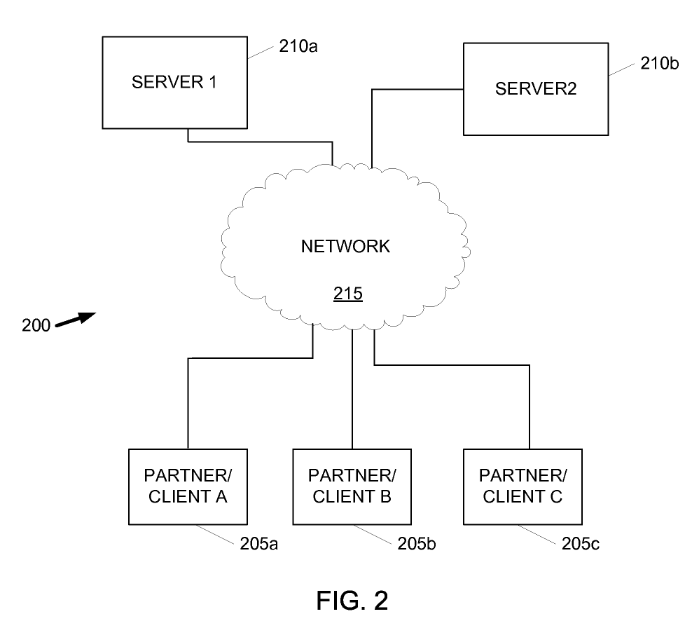

FIG. 2 illustrates a network environment in which a user may submit lease or contract information to an entity for evaluation and analysis. Network environment 200 includes client devices 205 and server 210. Client devices 205 may include mobile communication devices, personal computer (e.g., computer 100 of FIG. 1), personal data assistants (PDA) and the like. Each server 210a and b may correspond to a different entity or may be associated with the same entity. In one example, servers 210 may correspond to a financial company involved in the acquisition, renewal and disposition of various leases including property leases, product leases and the like. Client devices 205 may be associated with various partner entities that manage the leasing process for a particular lease. Such client or partner entities may include brokers, property management companies, agents and/or attorneys. Thus, in one or more arrangements, a server entity such as a financial company may hire a client entity such as a broker to obtain a lease for a particular piece of real estate. Client devices 205 may be used to enter and transmit information regarding lease terms and information to servers 210 through network 215. Servers 210 may then store the lease terms and information and evaluate the quality of the obtained lease. According to one or more aspects, a commission awarded to a client entity such as a broker may be determined based on the quality of the lease.

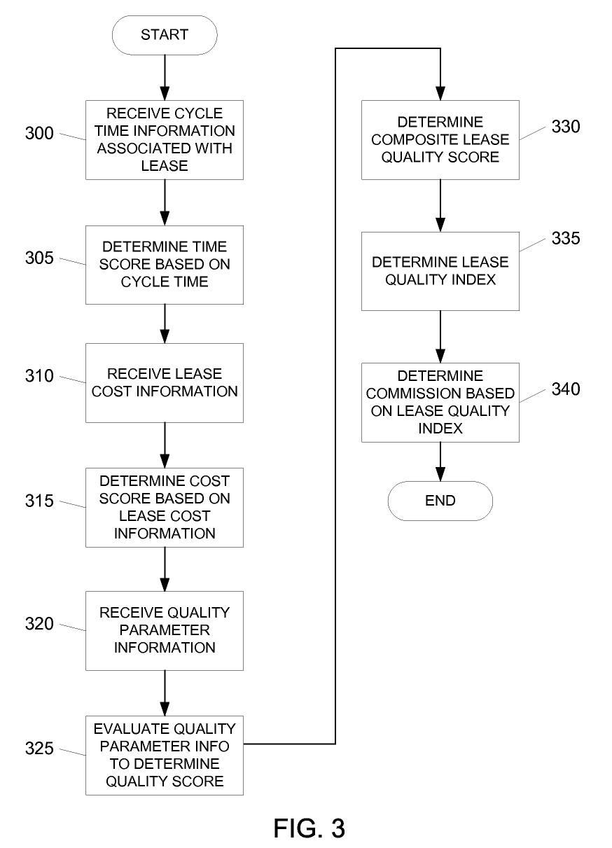

FIG. 3 is a flowchart illustrating a method for evaluating a lease agreement and determining a commission based on the evaluation. In step 300, a lease evaluation server may receive a cycle time that may indicate an amount of time spent obtaining the lease. A cycle time may be calculated based on a time lapsed between when a lease request is chartered and when a lease is approved (e.g., by the chartering entity). In step 305, the lease evaluation server may determine a time score based on the calculated cycle time. For example, the time quality score may be determined by comparing the cycle time to a scoring rubric that assigns points to various cycle times. In one arrangement, the scoring rubric may be derived from market data (e.g., lease completion times in the commercial real estate market or the automobile leasing market). In step 310, the lease evaluation server may receive cost information relating to the cost of the lease. A cost may be defined as the lease cost for a predefined amount of time, e.g., 1 month or 1 year. In step 315, a cost score may be determined based on the determined cost, e.g., by comparing the determined cost with a cost scoring rubric. In step 320, the server may receive quality parameter information associated with the lease agreement. The quality information may include lease provisions such as termination rights, expansion rights, signage provisions, right of first offer/refusal conditions (i.e., renewal options), exclusivity, sub-lease/assignment provisions and the like. In step 325, the quality information of the lease agreement may be evaluated to determine a quality score. For example, quality may be scored by totaling a number of points achieved by the lease agreement. Thus, if a lease agreement includes a termination right, a first number of points may be added to the quality score. Further, if the termination right lasts at least 50% of the life of the lease, a second number of points may also be added to the quality score. According to one or more aspects, a scoring rubric may be derived based on a valuation of various lease terms. Various quality criteria and scoring systems may also be used.

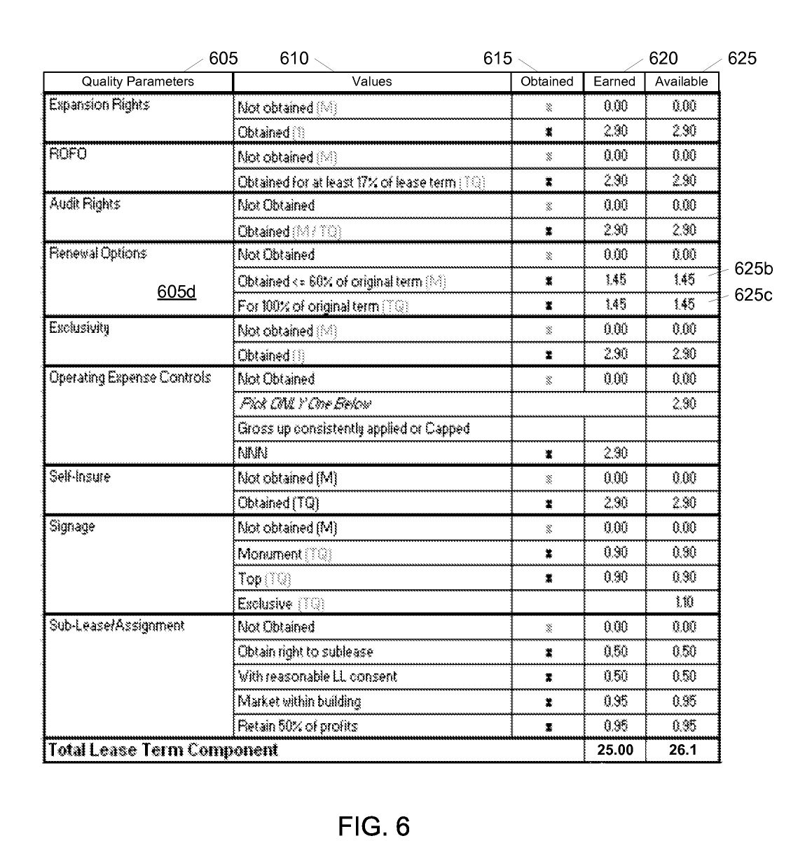

FIG. 6, for example, illustrates a quality parameters scoring chart or rubric. Chart 600 might or might not be provided to a partner entity. Chart 600 includes quality parameters 605, parameters values 610, obtained column 615, earned points 620 and available points 625. Parameter values 610 may be specific to each of quality parameters 605. For example, expansion rights parameter 605d may include values such as not obtained, obtained for <=60% of the original term, and obtained for 100% of original term. In one example, a partner entity may achieve multiple values such as obtained with 100% of original term. In such a case, corresponding points 625b and c may be awarded to the partner entity. The earned points may be identified in earned points column 620. A similar scoring chart or rubric may also be defined and used for evaluating time and cost aspects of a lease. For example, different number of points may be assigned for different lengths of completion time.

Referring again to FIG. 3, in step 330, a composite lease quality score may be determined based on the time, cost and quality scores determined in the steps described above. In one example, the composite lease quality score may be determined by adding each of the time, cost and quality scores. Alternatively or additionally, one or more of the component scores (i.e., time, cost and quality scores) may be weighed differently than the other scores. Various other algorithms may also be used to determine the composite quality score. In step 335, a lease quality index may be determined based on the composite lease quality score. In one or more arrangements, the lease quality index may correspond to the composite lease quality score. Alternatively or additionally, the lease quality index may represent where the composite lease quality score falls on a quality score curve. Once the lease quality index has been calculated, a commission may be determined for the broker or client that procured the lease in step 340. The commission may be a standard commission if the lease quality index corresponds to an average quality index (e.g., index corresponding to a media composite quality score). If, however, the lease quality index is greater than an average quality index, a bonus or a higher commission may be awarded. Alternatively or additionally, if the lease quality index is below average, the standard commission may be reduced.

In one or more configurations, the steps described with respect to FIG. 3 may be performed in a variety of orders. For example, the time, cost and quality score determination steps may be performed in any order and is not restricted to the order in which they are described herein.

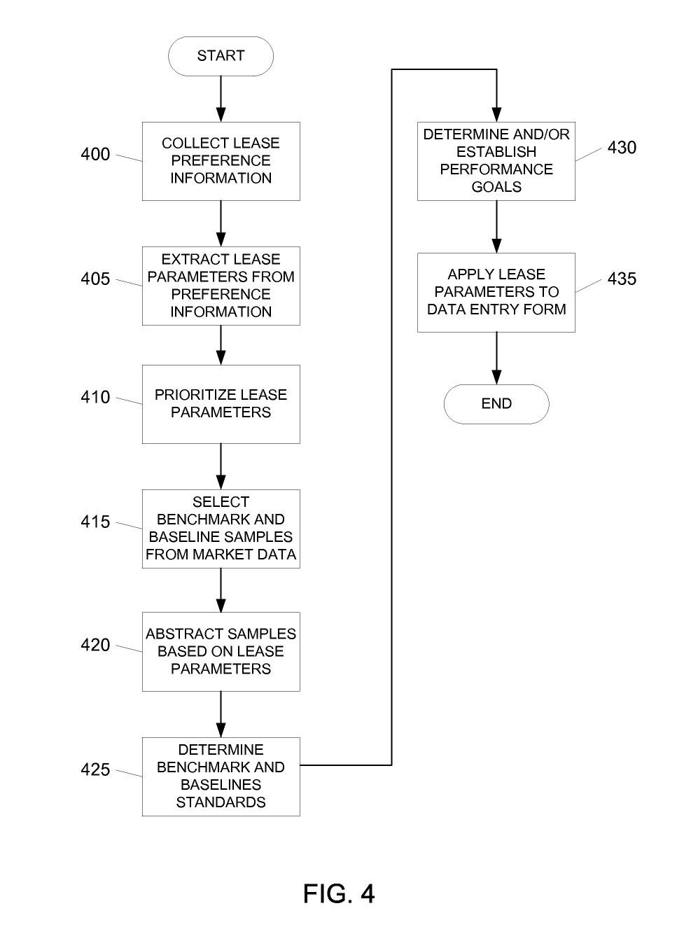

FIG. 4 is a flowchart illustrating a method for developing benchmarks and baselines for a lease quality index. In step 400, information regarding lease preferences may be collected from a variety of sources including lessees, loan officers, banks and the like. Lease preferences may include ideal or preferred cost ranges, time to delivery considerations and/or lease provisions that are desirable or undesirable. In step 405, lease quality parameters may be extracted from the information collected in step 400. That is, the preferred cost range, time to delivery and/or preferred lease provisions are identified from the collected data. In step 410, the various lease quality parameters may be prioritized. In one or more arrangements, the prioritization of the parameters may be performed based on input from interested parties. In step 415, benchmark and baseline samples may be selected from a pool of market data. Benchmark samples generally relate to data collected from external sources (e.g., leases completed by external entities), while baseline samples relate to samples selected from internal data (e.g., leases complete for internal entities). In one example, baseline samples may be selected from leases completed for a banking company while benchmark samples may be selected from leases completed for entities other than the banking company.

In step 420, the benchmark and baseline samples may be abstracted according to the extracted lease quality parameters. For example, a cost and time to delivery may be determined for each sample. Additionally or alternatively, the existence and/or extent of provisions specified in the lease quality parameters may be determined from each sample. In one example, a signage provision may have been identified as an important or otherwise significant lease quality parameter. In such a case, each sample may be evaluated to determine whether a signage provision exists and if so, the scope and coverage of the provision (e.g., duration of rights, size of signs). Once the samples have been analyzed according to the lease quality parameters, benchmark performance and baseline standards may be determined from the abstracted data in step 425. Benchmark and baseline standards may be determined, for example, by calculating a median value for each parameter in each of the benchmark samples and baseline samples. In step 430, performance goals may be established based on the determined benchmark and baseline standards. In one example, if benchmark samples show a higher average or median cost than the average or median cost of the baseline samples (or vice versa), a performance goal for cost may be set between the two samples.

In one or more arrangements, the extracted parameters may be applied to a data entry form or application used by brokers or other leasing partners to enter data relating to various leases in step 435. For example, a data collection template may be formed based on the identified parameters. Subsequently, the template may be used to create a web-entry form accessible through a network such as the Internet, allowing brokers and other partners to enter lease related information.

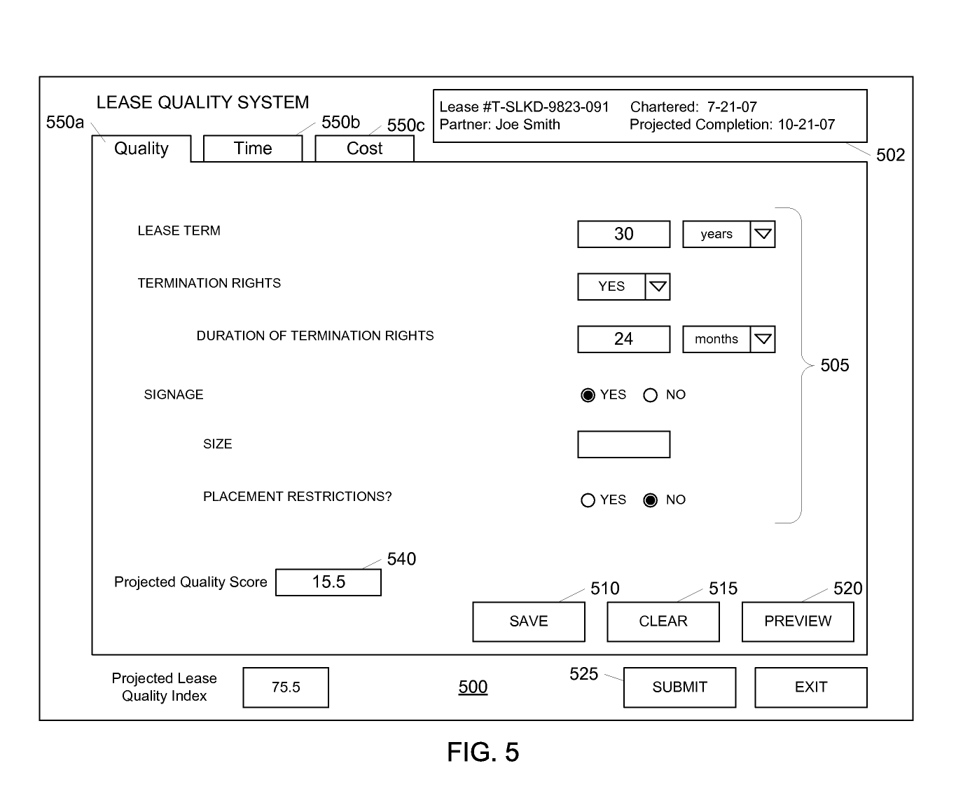

FIG. 5 illustrates a user interface through which a partner entity may enter lease quality information. Data entry form 500 may include lease identification information 502, multiple entry slots 505 corresponding to various time, cost and/or quality parameters, save option 510, clear option 515, preview option 520 and submit option 525. Lease identification information 502 may include a lease ID such as a number or alphanumeric code, date chartered, expected completion date, name of partner entity and the like. Entry slots 505 may include a variety of data input methods such as drop down menus, free-form entry slots, radio buttons and the like. In one or more configurations, a partner entity might not be required to complete all of the data entry slots 505. Instead, the partner entity may enter data in some slots, save the data, e.g., using save option 510, and recall the form at a later time when the partner entity is ready to enter additional information. Clear option 515 may be used by a partner entity to erase data entered in the form. Preview option 520, on the other hand, may allow a partner entity to view the data and/or form as it will be submitted to a reviewing entity. Once the partner entity has completed the form and/or is ready to submit the data to a review entity, the partner entity may select submit option 525.

Additionally or alternatively, form 500 may include quality index information such as a projected quality index 530. The projected quality index 530 may be provided to help a partner entity determine what parameters need to be adjusted in order to increase the projected index. Each component score, e.g., the projected quality score 540, may also be shown in form 500. Tabs 550 corresponding to various categories of lease parameters (e.g., time, cost and/or quality) may be included in form 500 for ease of viewing and entry. Thus, time parameters may be located on a first page identified by tab 550b while cost parameters may be located on a second page identified by tab 550c.

While lease quality indices have been discussed herein as being determined based on a combination of time, cost and quality parameters, a lease quality index may be determined based on a fewer or greater number of parameters. Thus, in one example, a lease quality index may be determined based on cost and quality parameters only or time and cost only or time, cost, quality and a fourth parameter such as partner responsiveness to inquiries. Further such lease quality indices may be used to evaluate not only new leases, but also dispositions, renewals and other lease transaction types. In a renewal, for example, a lease cost may be evaluated based on a comparison of a new lease cost and an old lease cost. Thus, if a partner entity is able to obtain a new lease cost that is 75% of the old lease cost, the cost score may be increased.

Additionally or alternatively, the methods and systems described herein may also be applied to instances where a partner entity is obtaining a lease for a lessor (i.e., rather than for a lessee). In such cases, the absence of certain provisions or rights might raise a cost, time or quality score. For example, if the lease is completed without termination rights for the lessee, additional points may be awarded for the quality score. In another example, if the lease cost is 25% more than market or more than a previous lease cost, a cost score may be increased. Further, other types of agreements or contracts may also be evaluated according to the aspects described herein. Quality elements and other components of a lease quality score or index may be modified according to the relevance and/or importance of those factors to the particular type of contract or agreement. For example, automobile leases may be analyzed to determine whether certain quality parameters have been met. In one instance, the procurement of an extended warranty provision may be awarded a first number of points while an extended warranty lasting a specified number of years may be awarded a second number of points (may be added on to the first number of points or may be awarded in place of the first number of points).

Additionally, the methods and features recited herein may further be implemented through any number of computer readable media that are able to store computer readable instructions. Examples of computer readable media that may be used include RAM, ROM, EEPROM, flash memory or other memory technology, CD-ROM, DVD, or other optical disk storage, magnetic cassettes, magnetic tape, magnetic storage and the like.

While illustrative systems and methods as described herein embodying various aspects are shown, it will be understood by those skilled in the art that the invention is not limited to these embodiments. Modifications may be made by those skilled in the art, particularly in light of the foregoing teachings. For example, each of the elements of the aforementioned embodiments may be utilized alone or in combination or subcombination with elements of the other embodiments. It will also be appreciated and understood that modifications may be made without departing from the true spirit and scope of the present invention. The description is thus to be regarded as illustrative instead of restrictive on the present invention.

We claim:

1. A method comprising:
receiving contract information including one or more contract provisions;
comparing the contract information to a plurality of evaluation criteria, wherein the plurality of evaluation criteria is associated with at least two of: time parameters, cost parameters and quality parameters; and
determining a composite quality index based on the comparison of the one or more contract provisions and the set of evaluation criteria.

2. The method of claim 1, further comprising determining a commission based on the determined composite quality index.

3. The method of claim 1, wherein the contract information includes a time needed to obtain the contract and wherein the plurality of evaluation criteria includes an average time needed to obtain a contract.

4. The method of claim 1, wherein a first evaluation criteria is weighted differently than a second evaluation criteria.

5. The method of claim 1, wherein the contract information is associated with a lease agreement.

6. The method of claim 5, wherein the plurality of evaluation criteria includes the existence of termination rights.

7. The method of claim 1, wherein the plurality of evaluation criteria are defined, at least in part, on market data.

8. One or more computer readable media storing computer readable instructions that, when executed, cause a processor to perform a method comprising:
receiving contract information including one or more contract provisions;
comparing the contract information to a plurality of evaluation criteria, wherein the plurality of evaluation criteria is associated with at least two of: time parameters, cost parameters and quality parameters; and
determining a composite quality index based on the comparison of the one or more contract provisions and the set of evaluation criteria.

9. The one or more computer readable media of claim 8, further comprising instructions for determining a commission based on the determined composite quality index.

10. The one or more computer readable media of claim 8, wherein the contract information includes a time needed to obtain the contract and wherein the plurality of evaluation criteria includes an average time needed to obtain a contract.

11. The one or more computer readable media of claim 8, wherein a first evaluation criteria is weighted differently than a second evaluation criteria.

12. The one or more computer readable media of claim 8, wherein the contract information is associated with a lease agreement.

13. The one or more computer readable media of claim 12, wherein the plurality of evaluation criteria includes the existence of termination rights.

14. The one or more computer readable media of claim 8, wherein the plurality of evaluation criteria are defined, at least in part, on market data.

15. An apparatus comprising:
a processor; and
memory configured to store computer readable instructions that, when executed by the processor, cause the processor to perform a method comprising:
receiving contract information including one or more contract provisions;
comparing the contract information to a plurality of evaluation criteria, wherein the plurality of evaluation criteria is associated with at least two of: time parameters, cost parameters and quality parameters; and
determining a composite quality index based on the comparison of the one or more contract provisions and the set of evaluation criteria.

16. The apparatus of claim 15, further comprising determining a commission based on the determined composite quality index.

17. The apparatus of claim 15, wherein the contract information includes a time needed to obtain the contract and wherein the plurality of evaluation criteria includes an average time needed to obtain a contract.

18. The apparatus of claim 15, wherein a first evaluation criteria is weighted differently than a second evaluation criteria.

19. The apparatus of claim 15, wherein the contract information is associated with a lease agreement.

20. The apparatus of claim 19, wherein the plurality of evaluation criteria includes the existence of termination rights.
